(19) United States
(12) Patent Application Publication
(10) Pub. No.: US 2012/0072287 A1
(43) Pub. Date: Mar. 22, 2012

(54) USING LOCATION FOR DETERMINING RELEVANCE BETWEEN QUERIES AND ADVERTISEMENTS

(75) Inventors: ANDREW S. CRANE, Seattle, WA (US); ANDRZEJ PASTUSIAK, Redmond, WA (US); DMITRY V. ZHIYANOV, Bothell, WA (US)

(73) Assignee: MICROSOFT CORPORATION, Redmond, WA (US)

(21) Appl. No.: 12/884,559

(22) Filed: Sep. 17, 2010

(51) Int. Cl. G06Q 30/00

(52) U.S. Cl. 705/14.58

(57) ABSTRACT

Relevance of advertisements provided in response to a query is improved based on locations associated with the query and the advertisement. A confidence level can optionally be determined for associated locations. The associated locations can be used to calculate a geographic distance between a query location and an advertisement location. A relevance can be determined for the advertisements based in part on the calculated geographic distances. The associated locations can also be compared to determine stacking and barrier relationships between locations.

### BACKGROUND

Traditionally, online advertisements that are displayed in response to a user-provided search query are contextually relevant to the user-provided search query. Therefore, the user is provided search results and advertisements that are relevant to the context of the user's query. Because the Internet serves a geographically disperse market, local advertisements that are contextually related to a nonlocal search query are displayed to the users without intent to look at local services, or the users that are not in a reasonable geographic proximity. As a result, advertisements that are not geographically relevant to the user are displayed to the user, which generally, does not benefit the user, the advertiser, or the financial benefactor of the Internet page from which the advertisement is displayed.

### SUMMARY

In an embodiment, relevance of advertisements provided in response to a query is improved based on locations associated with the query and the advertisement. A confidence level can optionally be determined for associated locations. The associated locations can be used to determine a distance between a query location and an advertisement location. Relevance of the advertisement to the search query can then be determined based in part on the determined distances and other features. The associated locations can also be compared to determine relationships between locations, such as instances where a first location is contained within a second location.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 is a block diagram of an exemplary computing environment suitable for use in implementing embodiments of the present invention.

FIG. 2 is a block diagram of an exemplary network computing environment suitable for use in implementing embodiments of the present invention.

FIG. 3 depicts a flow chart of a method according to an embodiment of the invention.

FIG. 4 depicts a flow chart of a method according to an embodiment of the invention.

FIG. 5 depicts a flow chart of a method according to an embodiment of the invention.

FIG. 6 schematically shows an example of input features for determining a relevance score.

### DETAILED DESCRIPTION

### Overview

In various embodiments, systems and methods are provided for using geographic factors to improve the relevance of advertisements selected based on a query, such as a search query. The system and method can allow for determination of a distance between a location associated with a search query and a location associated with an advertisement. Based on this distance, a geographic component can be included in a relevance score based on one or more distance-based relevance features. The relevance input can be further modified based on the confidence in the determined locations. Additionally, the system and method can allow for determination of the relationship between geographic areas. As an example, a dominant location for a query may be identified as a city. A county that contains the city may be identified for the location of a potentially relevant advertisement. This relationship, where the advertisement location contains the dominant location for the query, can be incorporated into the determination of the relevance score. The systems and methods can be used to provide for a two stage relevance determination. In a first stage, a larger group of advertisements can be selected in any convenient manner, such as based on conventional search query matching. The selected advertisements can then be filtered according to the invention based on a relevance score that includes geographic relevance features according to the invention.

In various embodiments, one or more of the following advantages may be provided by improving the geographic relevance of an advertisement delivered in response to a search query. One advantage can be avoiding the display of advertisements that match based on keywords but that are not relevant. A query of “restaurants in Bellevue Wash.” has a clear location for the query. Even though an advertisement for a restaurant in Bellevue, Ill. matches based on keywords, it is clearly not relevant for the user submitting the query. Another advantage can be correctly identifying abbreviated references or nicknames for a location. A search query including “SanFran Calif.” can be correctly correlated with a location of San Francisco Calif. Results matching this geographic location can then be provided, even though “SanFran” may not trigger a keyword match. Still another advantage can be providing advertisements that correspond to a larger region than the location for the query. An advertisement for the Washington State Department of Transportation can be a relevant ad for a query of “Get a driver license in Redmond Wash.”. Yet another advantage can be matching a query with a landing page, even though the location terms in the query and the location for the landing page do not explicitly match. A query for “camping rental in Redmond Wash.” can provide a match to a camping rental store in nearby Bellevue, Wash., even though the explicit query terms for location are not matched. This can be facilitated by converting the location for the query and advertisement to coordinates, such as GPS coordinates or latitude and longitude coordinates, and then calculating a distance between the locations.

Identifying Locations Associated with a Query Event

For a typical search or other event that leads to a query, at least three types of locations can potentially be associated with the search. A location can potentially be associated with the user performing the search, the document (such as an advertisement) that is responsive to the query, and the query itself.

Various techniques are available for identifying locations associated with a query event. For example, a location for a user that submits a search request can be based on several types of information. Some computing devices include a GPS or other location identification feature which can be directly used as a user location. Another option can be to identify a user location based on the network address the user is working from, such as by using a service for determining a location based on an IP address. Still another option can be to use a location explicitly provided by the user. This could be a location provided by the user during a current session, or a location provided by the user and stored as a profile. For example, a user could enter a default location of “Redmond, Wash.” into a profile that is saved. When the user logs in or otherwise authenticates an identity, this saved location is associated with the user. A profile location can also include an inferred location, such as a location determined based on various types of user activity. For example, even though a user has not provided an explicit location, the user may submit multiple searches for business within a geographic location. Alternatively, the user may perform searches that do not provide a location, but the user may typically select landing pages and/or advertisements that are associated with a geographic location. This type of inferred location information can be associated with the user profile.

A number of techniques are also available for identifying a location for a document responsive to a search, such as a potential landing page or an advertisement. In some situations, the owner of an advertisement will provide explicit location information for a desired advertising area, such as by including location information as a meta-tag for the advertisement. Alternatively, one or more physical locations belonging to an advertisement owner can be used. Still another option can be to detect a location based on the content of a document or advertisement. This can include inferring a location based on one or more geographic references within the advertisement. In still other embodiments, any convenient method for associating a location with a landing page or advertisement may be used.

Identifying a query location to associate with a query can provide additional challenges. Many queries (such as search queries) are presented as keyword strings containing only a few words. The keywords may provide a limited and/or incomplete geographic context, such as providing a city name without the corresponding state or county.

In an embodiment, a query location for a query can be determined by any convenient method. In another embodiment, an improved method can be used for determining a location associated with a query. The method can involve a two-stage machine learning technique to disambiguate queries when identifying a target location. A first stage can utilize a machine-learning model, such as a conditional random fields model, to determine if a search query is likely to contain a location. If a query is likely to contain a location, relevant words can be tagged along with the position of the words in the query text string. A second stage can identify potential matching location names. The second stage can also use a machine-learning model, such as logistic regression, to determine the likelihood of each particular location name. The location name with the highest likelihood can be selected as the dominant location for the query search. In an embodiment, the first stage can use the entire context of the query as well as knowledge of identified locations and their relationships, while the second stage can use attributes of the locations. Attributes may include location population, the vicinity of a user to a target location, as well as relationships to other locations tagged within a query. The method can utilize a location database of entities that includes, for example, countries, states, counties, cities, landmarks, and local services around the world, as well as relationships between these entities.

In an embodiment, extracting a location from a query q, comprising the search terms q=<t1, . . . , tn.>, can be divided into two separate tasks. The first task can be location extraction and tagging of terms in a query. Tagging can include assigning a label to each term in a query to identify possible location information. For example, for the query string q=<t1, . . . , tn>, a probability can be determined for one or more label sequences L=<11, 12, . . . , 1n>, where pr(L|q) is determined as the likelihood that a label sequence L is correct for the query q. The label contains information about the boundary of a location name in the query, as well as the location type. The location names of interest include country, state/province, county/district, city, local service entity (such as local TV/Radio stations, schools, sports teams, businesses, or the like), and other location types (such as lakes, islands, neighborhoods, and other points of interest).

To identify location name boundaries, a “start” or “continue” tag can be added to the label of a location. For example, the query “hotels in Los Angeles” can assign “City.Start” to “Los” to mark the start term of the city name, and “Angeles” can be labeled as “City.Continue.” Pre-amble and post-amble tags can be used for non-location terms before and after a location name, respectively, to differentiate between non-location names. In the previous example, the words “hotels” and “in” can be labeled as “city.Pre-amble.” Location boundaries, names, and types can be learned from query label sequences.

A machine learning model using conditional random fields can be used for location extraction and term tagging. This model can use a variety of features that correspond to the influence that words in a query have on a label. For example, when a city name appears at position i in previous queries, the likelihood that term i is labeled as a city in subsequent queries can be increased. More generally, word N-gram features can be utilized for predicting labels and/or context information to assign to various words. Tagging transitions are utilized to indicate how likely the model is to transition from one label to another and list features are utilized to indicate the likelihood of a label when the word is a member of a list. In addition to position features, context-matching features can also be activated when two different location terms within a query are correctly paired, such as “Seattle” and “Washington” but not “Seattle” and “Oregon.”

Based on the possible label sequences for a query, the probability or likelihood for a given label sequence can be computed. This probability can include any features that are activated for a label sequence. The labeling sequence with the highest likelihood can be selected to determine if a location is to be searched and an appropriate label (or tag) is placed on each term. Determining a location type of a location name can also assist disambiguation because multiple location types may have the same name.

An additional step can be performed whereby a query q, an extracted location name n, and a location type t, are utilized to find a likely location entity e, such that an expression pr(e|n, q, t) can represent the probability or likelihood that a location entity e is correct for n, q, and t. Features utilized to compute pr(e|n, q, t) for a candidate entity “e” may include type (country, state, county, city, local service, or the like), unique entity names, global location, context matches to other location terms in a query, entity popularity, prominent entities names, and an entity's proximal location to a searcher's IP address. A trained logistic regression model can be utilized for this purpose. For example, “hotels in Boston” has possible matches for cities named Boston in Ireland, England, Arkansas, Massachusetts, New York, and several others. The model can tag the term “Boston” with the label “city.start” and assign “Boston, Mass.” to the term because this city is the most populated and well known of all potential cities, and in the trained model this city will be scored the highest.

After a potential location name is correlated with a known location entity, the detected locations can be aggregated to determine the most probable target location. Preferably, a more specific location entity level can be utilized when a query contains multiple entity levels. For example, if a query includes the location “Boston Mass.,” then the entity corresponding to the city of “Boston, Mass.” is returned, rather than just the state of Massachusetts.

In some embodiments, a gazetteer or other type of location database can be used to provide information about potential entities for assignment as a location. A location database can include a variety of information regarding a location entity, including location name, location nicknames or equivalents (such as SanFran for San Francisco, Calif.), latitude and longitude coordinates, size, and population. The location database can also include relationships between entities. For example, the city of San Francisco is part of San Francisco county, which is part of the state of California, which is part of the United States.

Note that when a location is being associated with a query, the user location can be beneficial for determining a query location. For example, a search query for “restaurants in Riverside” clearly has a location context. However, this context can be difficult to determine, as many states have a city named Riverside, but none of these instances may stand out as most likely based on factors such as population or popularity. In this situation, user location information can be used in associating a location with the query, such as by associating the instance of Riverside that is closest to the user location. Alternatively, the user location can be used as a weighting factor in associating a query with a location. In an embodiment, the weighting of features related to user location in a determining a location for a query can be determined using a machine learning model based on training data.

Relationships Between Locations Associated with a Query Event

When a search query or other query is identified as being associated with a query location, a relationship can be determined between the query location and an ad location. One potential type of relationship is a distance relationship. To determine a distance relationship, the query location and the ad location can be converted to coordinates of some type, such as latitude and longitude. A distance between the locations can then be calculated using standard geometric formulas.

Another type of relationship can be a stacking relationship between two locations, indicating that one location is within the boundaries of a second location. For example, a query may have a query location of Redmond, Wash. An advertisement may have a location of King County, Wash. Because Redmond is a city within King County, these locations have a stacking relationship. Rather than attempting to calculate a distance relationship between the query location and the advertisement location, the stacking relationship of the locations can be used in a relevance determination.

Still another type of relationship can be a barrier relationship between two locations. A barrier relationship can occur when an apparently nearby advertisement location is not relevant due to a geographical divider of some type between the query location and the advertisement location. For example, a user that searches for a grocery store is likely not concerned with whether the store is in the same city, county, and/or state as the user. So long as the store is nearby, it will meet the user's needs. By contrast, a search for government or legal services is likely to be sensitive to state line boundaries. Thus, a law firm near to the query location but across the state line is likely not as relevant as a law firm within the same state as the user. As indicated by the above example, the importance of a barrier relationship can be dependent on the subject matter of the search query. An international boundary between two countries can provide a more general example of a barrier relationship. Due to the additional time required to cross an international border, an advertisement with a location in a different country than the query location is likely less relevant than an advertisement within the same country. Other factors that can influence the importance of a barrier relationship can be legal issues such as tax regulations.

In an embodiment where one or more location databases are used, a location database can include information regarding stacking and barrier relationships. For example, a location database entry for King County in the state of Washington could include Seattle and Redmond as locations within King County, while indicating Washington and the United States as entities that contain King County. In addition, a location database can include information about potential barrier relationships. For example, a location database entry for El Paso, Tex. could include Ciudad Juarez, Mexico, and New Mexico as location entities that may have a barrier relationship, depending on the subject matter of the search. Note that a city in Mexico and the neighboring state of New Mexico will likely have different types of barrier relationships.

### Selection and Filtering of Advertisements

Based on association of a query with a location, the location information can be used to assist with filtering of potential advertisements for display. Filtering can include a variety of tasks. One set of tasks can involve determining a quality of correlation between a query location and a query. First, a determination can be made as to whether there is enough confidence associated with an associated location to consider the location information. If a query contains little or no information regarding location, the probability for correctly associating a location may be low. Alternatively, all of the location information for the query may be based on information related to the user location rather than the query itself. In such situations, a determination can be made that no location is associated with the query. If a user location is available, the user location can be compared with the location associated with an advertisement as a separate factor.

After determining whether a location can be associated with the query, the level of confidence in the association can be determined. Based on the method for associating a query with a location, a probability or likelihood that the association is correct may already be available. While this probability or likelihood could be used directly, many types of search engines are based on relevance factors with binary states for filtering search results. For example, if a machine learning model is used to assign weights to various factors considered during filtering, it can be helpful to have features with binary states. Thus, one option can be to compare the probability of a correct location with a series of confidence ranges. In an embodiment where three confidence ranges are used, the confidence ranges can qualitatively be thought of as providing “low”, “medium”, and “high” probabilities of a correct correlation for the query location. Other embodiments can involve any number of desired confidence ranges.

In some optional embodiments, a confidence can also be determined for the location of the advertisement. If an advertiser has explicitly set a location for the advertisement, the confidence can default to a high confidence. Alternatively, if the advertisement location is determined based on factors within the advertisement, a confidence level may be available based on the method used for associating a location with the advertisement.

After determining a quality of correlation between a query and a query location, the correlated query location can be compared to locations for advertisements that are being filtered. The comparison of the query location to the advertisement location can include several factors. One factor can be whether the query location and the advertisement location have a stacking relationship. For example, if the query location is a city while the advertisement location is a county or state containing the city, the locations have a stacking relationship. A “distance” between locations having a stacking relationship may not be appropriate, as one location is contained within a second location. Instead, the stacking relationship can be used as a factor for determining the relevance of the advertisement. A stacking relationship can refer to a situation where the query location is contained within the advertisement location, and therefore is a subset of the advertisement location. A stacking relationship can also refer to the advertisement location being a subset of the query location.

A second factor can be whether the query location and the advertisement location have a barrier relationship. A barrier relationship could be used as a factor in several manners. One option could be to use the barrier relationship as a factor for all queries. A second option could be to have the barrier relationship be a factor for queries related to a type of subject matter. Thus, barrier relationships could be considered for queries related to government entities or services, legal services, car rental or purchase, real estate rental or purchase, or any other type of query where a geographic or jurisdictional boundary may be relevant. Note that a distance between a query location and advertisement location may still be relevant when a barrier relationship is identified.

Still another factor can be a geographic distance between a query location and an advertisement location. A set of coordinates can be available for the query location and advertisement location, such as GPS coordinates or latitude and longitude. The location information can be stored in a location database or another storage location. Based on the coordinates, a geographic distance between the query location and the advertisement location can be determined. If desired, this geographic distance can then be used in comparison with one or more binary factors, such as distance ranges between the query location and the ad location. For example, binary factors for consideration could be locations that are exact matches, locations within 10 miles of each other, locations within 25 miles, locations within 100 miles, and/or locations greater than 100 miles apart.

Based on the above, a variety of binary factors can be developed for incorporation into a filtering system. The following are a few examples of factors that could be used as part of a relevance determination: a) No location for query or ad; b) No location for query, but user location is within a distance range (such as 25 miles) of ad location; c) at least medium confidence in both ad location and query location, locations within 10 miles of each other; d) high confidence in both query location and ad location, ad location is within query location (a stacking relationship); e) low confidence in query location, high confidence in ad location, locations have barrier relationship; f) at least low confidence in both query location and ad location, locations are at least 100 miles apart. The above factors are only examples, and some, all, or none of the above factors could be used as part of a series of factors for determining relevance based on geographic information.

Determining the relevance of an advertisement can be used as part of a two stage process for identifying relevant advertisements. In a first stage, an initial selection of advertisements can be made, such as selection based on conventional keyword matching. The relevance of these initially selected advertisements can be determined based on various features, including geographic distance-based features. In such a two stage process, the initial selection of advertisements can be used to reduce the overall number of ads, and then a more detailed relevance determination can be performed. This can allow a more computationally expensive relevance determination process to be used while reducing the amount of resources needed for filtering for a given search query.

An initial selection of advertisements to match a search query can be performed using any convenient method. This can be based on keyword matching, including differentiating between advertisements based on multiple uses of a keyword or the location of a keyword in an advertisement. The initial selection can be used to identify a smaller set of advertisements that can be subjected to a more detailed relevance determination. In some embodiments, it can be beneficial to have an initial selection that includes a larger number of advertisements, as the relevance determination stage is only performed on the selected documents. Thus, a stringent set of selection criteria could result in an advertisement that is geographically relevant being excluded based on poor matching of geography-related keywords.

### Example of Operating Environment

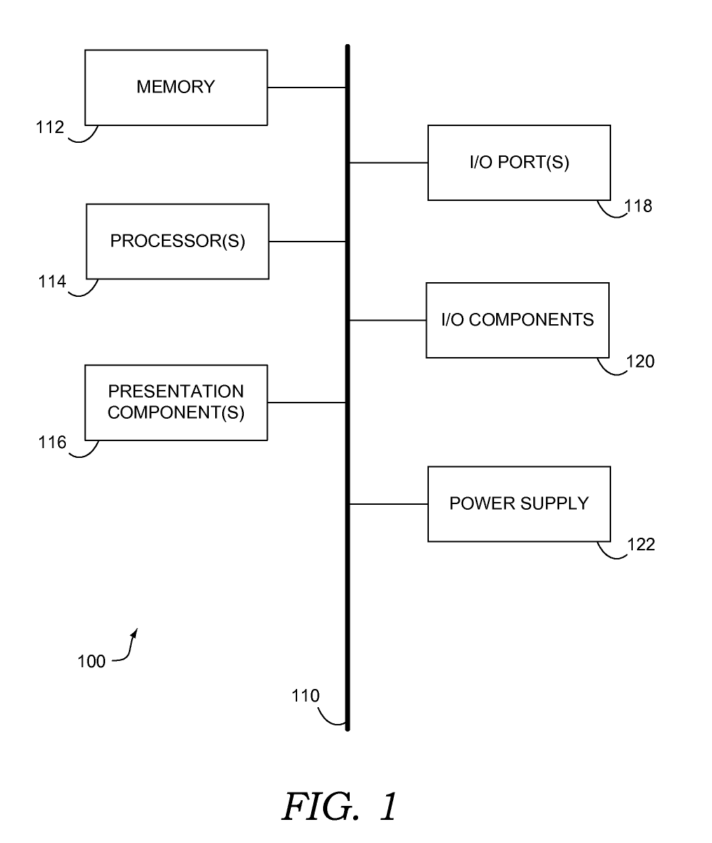

Having briefly described an overview of various embodiments of the invention, an exemplary operating environment suitable for performing the invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 100. In an embodiment, the computer storage media can be selected from tangible computer storage media. In another embodiment, the computer storage media can be selected from non-transitory computer storage media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

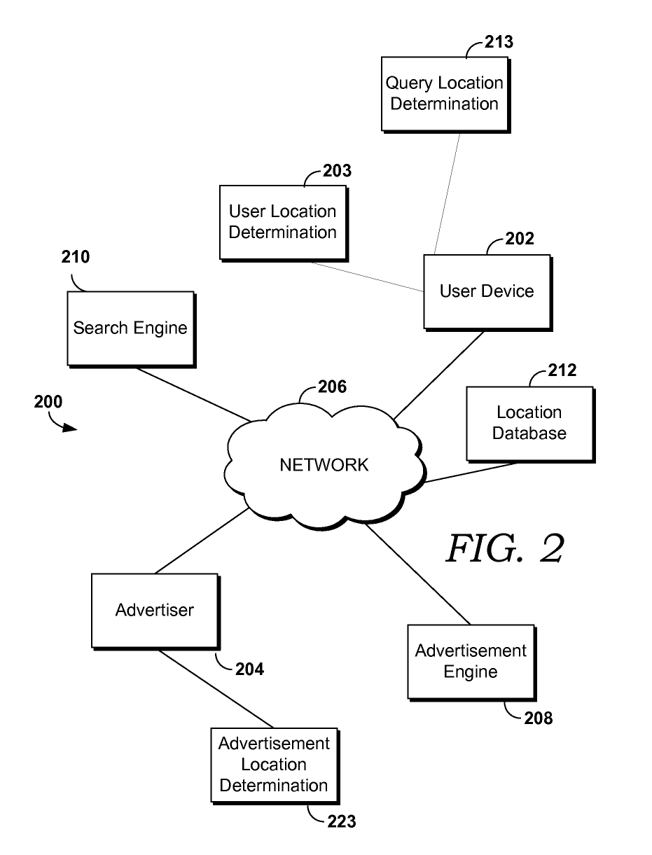

FIG. 2 schematically shows a computing environment suitable for performing an embodiment of the invention, as generally depicted by a numeral 200. Environment 200 includes an end user device 202, an advertiser and/or publisher 204, a network 206, a geographical based advertisement engine 208, a search engine 210, and a location database 212. Based on the available location information, advertisements, and the query, an advertisement engine 208 can transmit an advertisement to user device 202. FIG. 2 is not intended to be limiting as to the scope of the present application, but instead provides a visual depiction as to an exemplary environment for geographically targeting online advertisements. Additionally, the inclusion or exclusion of any one, or combination of, modules and elements of FIG. 2 is not limiting as to the scope of the present application.

The end user device 202 can be an originating source of a search query to which geographically relevant advertisements are matched. In an exemplary embodiment, the end user device 202 is a computing device, such as the computing device 100 previously discussed with reference to FIG. 1. Additionally, in an exemplary embodiment, the end user device 202 functions to present the geographically relevant advertisements to the user. The search query originates in response to, for example, a search engine 210. In other embodiments, a mobile search platform, a directory, and/or a classified listing service can be used in place of or in addition to search engine 210.

In an exemplary embodiment, the end user device 202 allows a user to input a search query to be handled by a search engine 210 that is accessible by way of the network 206. For example, the end user device 202 can include a display screen, such as the presentation module 116 previously discussed with respect to computing device 100. The display screen allows a user of the end user device 202 to view the search engine and to enter a search query by way of textually based commands, on-screen selection commands, and/or voice commands by way of an input module, such as I/O module 120.

Additionally, in an exemplary embodiment, the end user device 202 can be a mobile communications device. A mobile communications device is functional to communicate by way of a wireless telecommunications network. For example, a wireless telecommunications network utilizes technologies compatible with the Third Generation Partnership Project (3GPP), the Third Generation Partnership Project 2 (3GPP2), IEEE 802.16 (e.g., WirelessMAN), and IEEE 802.11 (e.g. WiFi). 3GPP covers, among other technologies, all GSM technologies including General Packet Radio Service (GPRS) and Enhanced Data rates for GSM Evolution (EDGE) and W-CDMA specifications. 3GPP2 covers, among other technologies, Code Division Multiplexing (CDMA) 2000, a 3G standard based on earlier CDMA technologies. Therefore, the end user device 202 can be capable of communicating with the search engine by way of a wireless telecommunications network. Examples of mobile communications devices include wireless phones, cellular phones, smart phones, Personal Data Assistants (PDA), and mobile computing devices.

In an additional exemplary embodiment, the end user device 202 can include a location determination module 203. The location determination module 203 determines the location of the end user device 202. For example, the location determination module 203 is compatible with a Global Positioning System (GPS) that is capable to determine the latitude and longitude of the end user device 202. In an additional exemplary embodiment, the location determination module 203 determines the approximate location of the end user device 202 utilizing trilateration. Trilateration uses the known locations of two or more reference points, such as mobile communications network transceivers, and the measured distance between the end user device 202 and each reference point. Another exemplary embodiment utilizes triangulation to determine the location of the end user device 202. Yet another exemplary embodiment utilizes multilateration to determine the approximate location of the end user device 202. Multilateration, also known as hyperbolic positioning, is the process of locating an object by accurately computing the time difference of arrival (TDOA) of a signal emitted from the object, such as the end user device 202, to three or more receivers. It also refers to the case of locating end user device 202 by measuring the TDOA of a signal transmitted from three or more synchronized transmitters to the end user device 202.

In another exemplary embodiment, the location of the end user device 202 is determinable based on a known home location of the end user device 202. For example, the end user device 202 is associated with a profile that includes the general location from which the end user device 202 typically operates. This area that the end user device 202 typically operates is the end user's 202 home location. In an additional embodiment the end user's 202 home location is associated with a mobile communications device profile. Additionally, in an exemplary embodiment, the location of the end user device 202 is determinable based on an Internet Protocol (IP) address or other comparable identifier assigned to the end user device 202. IP addresses typically provide and indication as to the general geographic location of a computing device, such as end user device 202, by utilization of a reverse IP lookup based on the access point identification from which the end user device 202 is communicating. Alternatively, the location of the end user device 202 can also be determined based on input provided by the user of the end user device 202. For example, the user of the end user device 202 can provide a country/state/city, an address, latitude/longitude coordinates, and a point of interest (such as a known landmark or known location).

The above-discussed embodiments for determining the location of the end user device 202 are merely exemplary and are not limiting as to the scope of the present application. Additionally, it is understood that any combination of the embodiments for determining the location of the end user device 202 are functional to determine the location of the end user device 202.

The end user device 202 can also include a query location component 213. Alternatively, query location component 213 can be a stand-alone component, or can be part of any other convenient component such as search engine 210. Query location component 213 can determine a query location based on the context of a search query provided by way of the end user device 202. For example, if the search query includes an eating establishment that is determined to be in a single location, the query location can be inferred based on the context of the search query. More generally, the structure of the query and/or any query terms that provide geographic information can be used to associate a query location with a query. The query location can be associated with a query using any convenient method, such as a machine learning model using conditional random fields as described above. Optionally, the query location component 213 can also determine a confidence level for the query location associated with a query.

Query location component 213 can optionally use location database 210 to assist with associating a query with a query location. Location database 210 can include information regarding the coordinates for a location, such as a landmark, city, county, or state. Location database 210 can also include information that can be helpful in identifying a location. This information can include various alternative names or nicknames that may be used when referring to a location. Location database 210 can also include other information regarding a location, such as population, size of the location, or popularity in search queries. Additionally, location database 210 can include information regarding stacking relationships and barrier relationships between locations.

The advertiser 204 can be a source of online advertisements. In an exemplary embodiment, the advertiser 204 is a computing device, such as computing device 100 previously discussed with respect to FIG. 1. The advertiser 204 facilitates the submission of online advertisements that are intended to be presented in response to a search query, such as a search query originating from the end user device 202. In an exemplary embodiment, an advertising entity, such as a marketing company or a purveyor of goods and/or services, will generate advertisements to be displayed to an audience. The advertisements created by the advertising entity are provided to the audience, in part, by the advertiser 204. For example, the advertiser 204 includes a user interface that facilitates the generation and submission of advertisements that will be displayed in response to a search query. It is noted that in some embodiments, some of the roles described as part of advertiser 204 may be provided by a separate publishing entity. For example, advertiser 204 can represent two devices. A first device can correspond to a device associated with the creator of the advertisement. The creator can forward the advertisement to a second device associated with a publisher. The publisher can then provide the advertisement in association with a relevant search request.

In an exemplary embodiment, the advertiser 204 can facilitate the association of a geographic location with an advertisement. For example, an advertisement location can be designated by the advertiser. The advertisement location can represent a set of coordinates and a shape surrounding the coordinates (such as a bounding circle), a neighborhood, a city, or any other convenient way of expressing an area. Alternatively, an advertising location can be set and/or inferred based on physical locations corresponding to the advertiser. Still another option can be to determine a location based on the content of an advertisement. An advertisement location determination component 223 can be used for determining a location as described above.

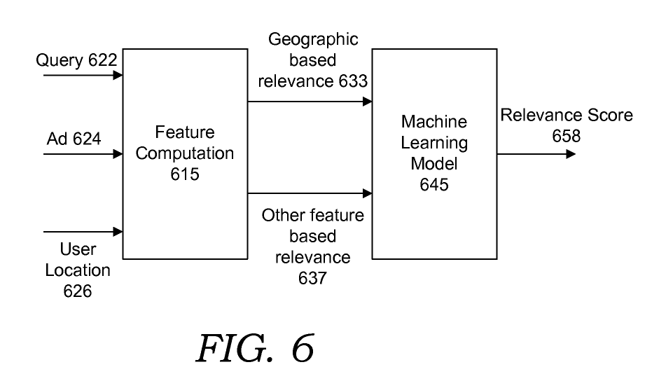

FIG. 6 shows an example of the types of input that can be used for determining a relevance score. In FIG. 6, three sources of input are schematically shown. The indicated sources of input are a query 622, an advertisement 624, and a user location 626. These inputs are schematic representations so, for example, advertisement 624 includes any information associated with an advertisement. This could include an advertisement location based on the location of the advertiser, even though the text of the advertisement does not include the location information. Based on the input sources, a feature computation engine 615 can determine whether a variety of features are present in the combined inputs. As described above, some of these features can be geographic based features 633. Other features 637 can also be determined. These other features can include, for example, conventional relevance based features, such as a feature based on the number of times a keyword in query 622 appears in a document. The features identified by feature computation engine 615 can be used as inputs for a machine learning model 645. The machine learning model 645 assigns weights to various features in order to arrive at a relevance that is based on the features, such as a relevance score 658.

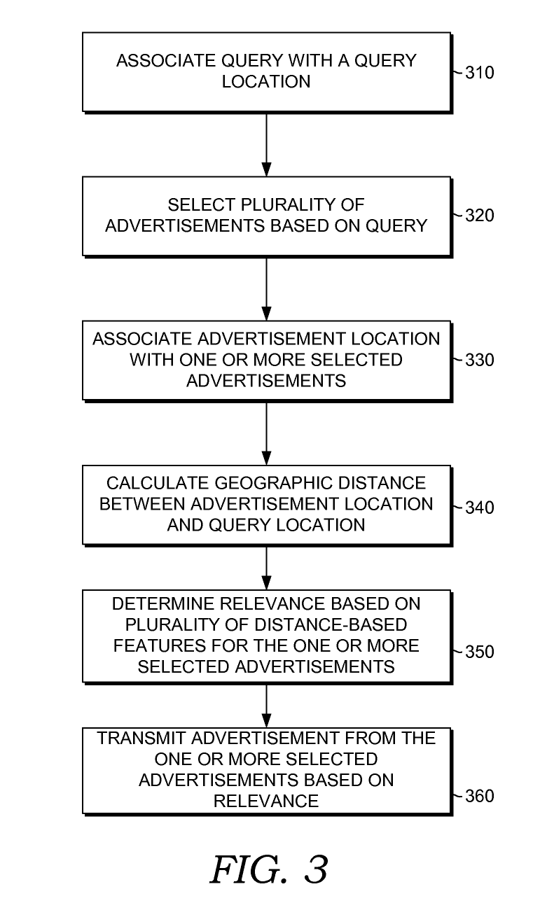

FIG. 3 schematically shows an example of a method according to an embodiment of the invention. A query location is associated 310 with a query. A plurality of advertisements are also selected 320 based on the query. An advertisement location is associated 330 with one or more of the selected advertisements. A distance is calculated 340 between the query location and the advertisement location for the one or more selected advertisements. A relevance is determined 350 for the one or more selected advertisements. The relevance can be in the form of a relevance score. The relevance is based in part on a comparison of the calculated geographic distance with a plurality of distance-based features. The distance-based features for comparison can be selected based on a confidence level for at least one of the query location and the advertisement location. An advertisement is then transmitted 360 based on the determined relevance for the one or more selected advertisements.

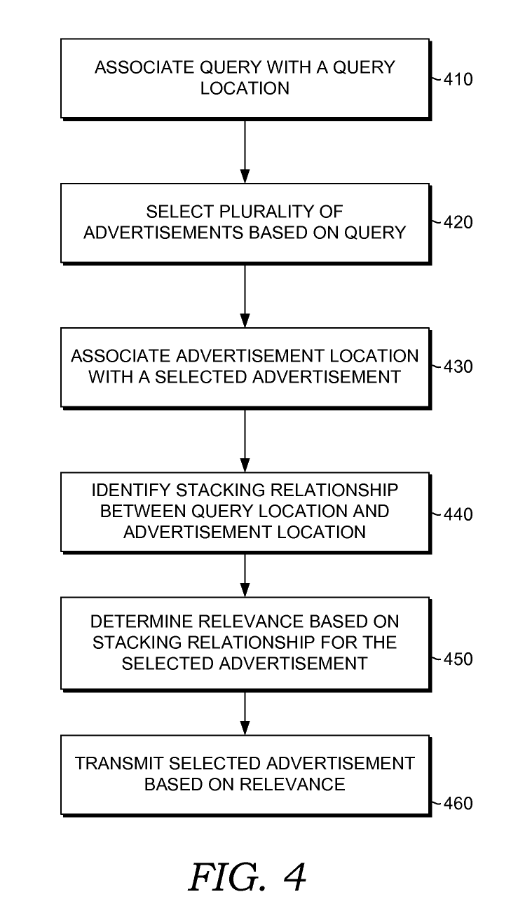

FIG. 4 schematically shows an example of a method according to another embodiment of the invention. A query location is associated 410 with a query. A plurality of advertisements are also selected 420 based on the query. An advertisement location is associated 430 with a selected advertisement. A stacking relationship is identified 440 between the query location and the advertisement location. The stacking relationship corresponds to either the query location being a subset of the advertisement location, or the advertisement location being a subset of the query location. A relevance, such as a relevance score, is determined 450 for the selected advertisement. The relevance is based in part on the stacking relationship between the query location and the advertisement location. The selected advertisement is then transmitted 460 based on the determined relevance score.

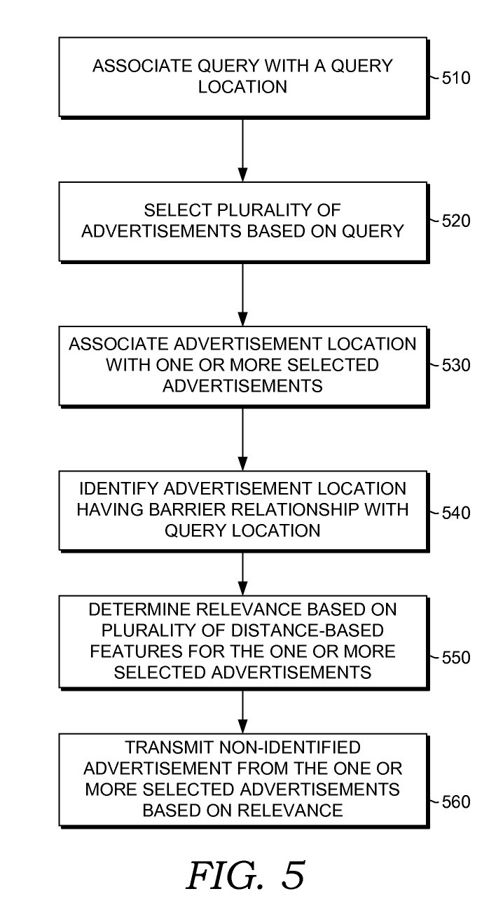

FIG. 5 schematically shows an example of a method according to another embodiment of the invention. A query location is associated 510 with a query. A plurality of advertisements is also selected 520 based on the query. An advertisement location is associated 530 with one or more of the selected advertisements. At least one advertisement location is identified 540 that has a barrier relationship with the query location. A relevance, such as a relevance score, is determined 550 for the one or more selected advertisements. The relevance is based in part on a comparison of a calculated geographic distance, such as the geographic distance between the query location and the advertisement location, with a plurality of distance-based features. An advertisement from the one or more selected advertisements is transmitted 560 based on the determined relevance. The transmitted advertisement does not correspond to an advertisement location that was identified 540 as having a barrier relationship with the query location.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for providing advertisements based on geographic relevance comprising:
associating a query location with a query;
selecting a plurality of advertisements based on the query;
associating an advertisement location with one or more of the selected advertisements;
calculating a geographic distance between the advertisement location for the one or more selected advertisements and the query location;
determining a relevance for the one or more selected advertisements, the relevance score being based in part on a comparison of the calculated geographic distance with a plurality of distance-based features, the plurality of distance-based features being selected based on a confidence level corresponding to at least one of the query location and the advertisement location;
transmitting an advertisement from the one or more selected advertisements based on the determined relevance.

2. The one or more computer-storage media of claim 1, wherein the plurality of distance-based features are selected based on the query location confidence level.

3. The one or more computer-storage media of claim 1, wherein the plurality of distance-based features are selected based on the advertisement location confidence level.

4. The one or more computer-storage media of claim 1, wherein at least one advertisement location has a barrier relationship relative to the query location.

5. The one or more computer-storage media of claim 1, wherein associating a query location with a query comprises tagging keywords within the query to form a label sequence.

6. The one or more computer-storage media of claim 5, wherein the confidence level for the query location corresponds to a probability associated with the label sequence for the associated query.

7. The one or more computer-storage media of claim 1, wherein the query location is associated with the query based on a machine learning model using conditional random fields.

8. The one or more computer-storage media of claim 1, wherein the query location is associated with the query based on a proximity of a user location to the advertisement location.

9. The one or more computer-storage media of claim 1, wherein the query location is associated with the query based on at least one of a size of the query location and a population of the query location.

10. The one or more computer-storage media of claim 1, wherein associating an advertisement location with an advertisement comprises extracting location information from the advertisement.

11. A method for providing advertisements based on geographic relevance comprising:
associating a query location with a query;
selecting a plurality of advertisements based on the query;
associating an advertisement location with a selected advertisement;
identifying a stacking relationship between the query location and the advertisement location, the stacking relationship corresponding to either the query location being a subset of the advertisement location or the advertisement location being a subset of the query location;
determining a relevance for the selected advertisement, the relevance being based in part on the stacking relationship;
transmitting the selected advertisement based on the determined relevance.

12. The method of claim 11, wherein the stacking relationship has a confidence level based on a confidence level of at least one of the query location and the advertisement location.

13. The method of claim 11, wherein associating a query location with a query comprises tagging keywords within the query to form a label sequence.

14. The method of claim 13, wherein the confidence level for the query location corresponds to a probability associated with the label sequence for the associated query.

15. The method of claim 11, wherein the query location is associated with the query based on a machine learning model using conditional random fields.

16. One or more computer-storage media storing computer-useable instructions that, when executed by a computing device, perform a method for providing advertisements based on geographic relevance comprising:
associating a query location with a query;
selecting a plurality of advertisements based on the query;
associating an advertisement location with one or more of the selected advertisements;
identifying at least one advertisement location having a barrier relationship with the query location;
determining a relevance for the one or more selected advertisements, the relevance score being based in part on a comparison of a calculated geographic distance with a plurality of distance-based features;
transmitting an advertisement from the one or more selected advertisements based on the determined relevance, wherein the transmitted advertisement does not correspond to an identified advertisement location.

17. The one or more computer-storage media of claim 16, wherein associating a query location with a query comprises tagging keywords within the query to form a label sequence.

18. The one or more computer-storage media of claim 17, wherein the confidence level for the query location corresponds to a probability associated with the label sequence for the associated query.

19. The one or more computer-storage media of claim 16, wherein the query location is associated with the query based on a machine learning model using conditional random fields.

20. The one or more computer-storage media of claim 16, wherein the barrier relationship corresponds to the query location and the advertisement location being separated by an international boundary.
